(19) United States
(12) Patent Application Publication
(10) Pub. No.: US 2007/0021216 A1
(43) Pub. Date: Jan. 25, 2007

(54) Seamless gaming method and apparatus

(75) Inventor: Guru Corattur Sambandam Guruparan, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/184,469

(22) Filed: Jul. 19, 2005

(51) Int. Cl. A63F 13/00

(52) U.S. Cl. 463/43

(57) ABSTRACT

The present invention describes a method and an apparatus for playing electronic games via an online network. In particular, the present invention provides means for players to switch between different game devices without losing their place in the game. Generally, when a player playing a game on a game console wishes to switch to a mobile device, the player saves a current game state and transfers the current game state to the mobile device. The player then player resumes the game from the saved game state using the mobile device. As such, the player can resume the game on the mobile device from where he or she left off on the game console instead of having to resign from the game.

### BACKGROUND

This invention relates generally to electronic gaming systems, and more particularly to online electronic games played on mobile devices.

Over the past twenty-five years, gaming technology has advanced from simple Pong® and Tetris® games to complex shooter and sports games that have high-speed graphics and multi-player options. These sophisticated features increase players' interest in the games. For example, multi-player options enable players from all over the globe to participate in a single game using one or more game consoles interconnected by an online network, such as the Internet. As a result, players have access to a larger number and wider range of opponents, which increases the players' interest in purchasing and playing the game.

There are many occasions when a player participating in a multi-player game can no longer continue playing the game using the game console, e.g., when it is time to leave home to go to swim practice, Grandma's house, etc. Because there is currently no way for players to continue playing a currently established game on a mobile device, the player must exit the game and re-enter the game at a later time as a new player.

### SUMMARY

The present invention provides a method and an apparatus for switching between a game console and a mobile device to enable players to continue playing electronic games via an online network without losing their place in the game. According to the present invention, one or more players establish a game over an online network. When a player wishes to switch from the game console to a mobile device, the game console saves a current game state of the game. After transferring the saved game state to the mobile device, the mobile device resumes the game from the saved game state. As a result, the player can continue the game on the mobile device from the saved game state instead of resigning from the game. In addition, when the player is ready to resume game play on the game console, the mobile device may save a new game state, which can be transferred back to the game console.

### BRIEF DESCRIPTION OF THE DRAWINGS

FIG. 1 illustrates a functional block diagram of an online network according to one exemplary embodiment of the present invention.

FIG. 2 illustrates a block diagram of the basic components of one exemplary IP multimedia subsystem (IMS).

FIG. 3 illustrates a block diagram of a mobile device according to one exemplary embodiment of the present invention.

FIG. 4 illustrates one exemplary method for implementing the present invention.

FIG. 5 illustrates a functional block diagram of a mobile device interfacing with a game console according to the present invention.

### DETAILED DESCRIPTION

The present invention enables a player to switch between gaming devices, i.e., between game consoles and mobile gaming devices, while participating in an online game. Generally, the method and apparatus described herein saves a current game state on a game console, transfers the current game state to a mobile device, and resumes the game from the saved game state over an online network using the mobile device. Before additional details of the present invention are presented, the following provides an overview of an exemplary online network and how the online network implements a multi-player electronic game.

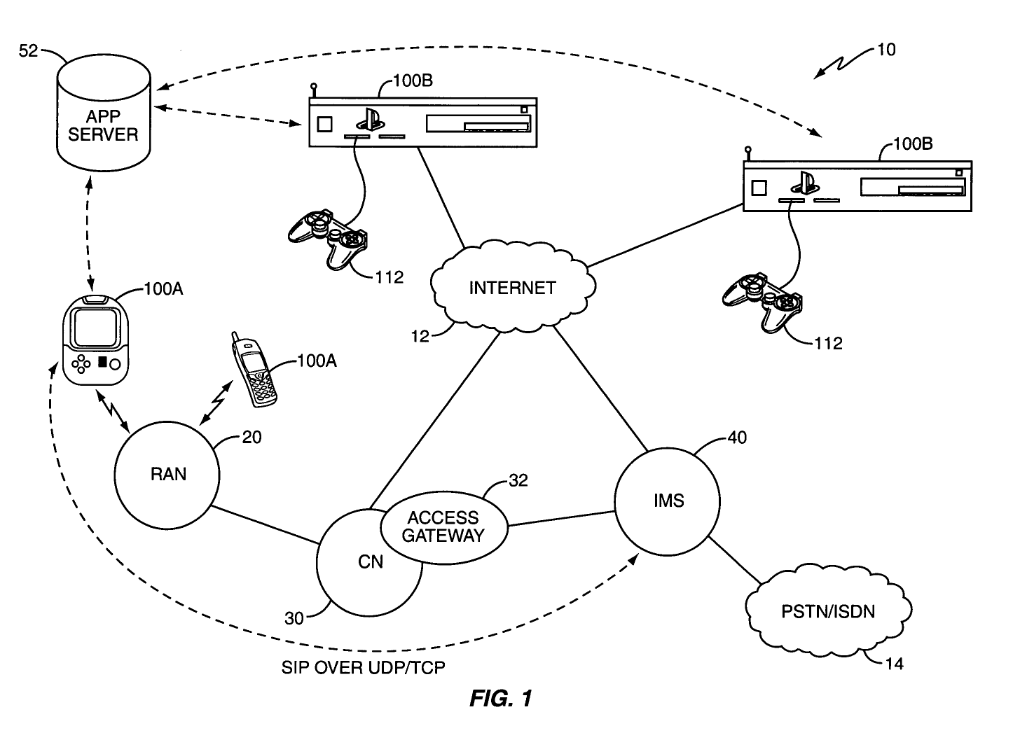

FIG. 1 illustrates a mobile communication network 10 in which the present invention may be employed. While the present invention is described in the context of a mobile communication network 10 used for communications between mobile devices 100A, those skilled in the art will appreciate that the present invention may also be used in fixed networks for communications between fixed gaming devices 100B. The term “gaming device” as used herein therefore includes any wireless or fixed device capable executing program code for a game and communicating over a network, such as the Internet, using a fixed or wireless connection. Exemplary gaming devices 100 include, but are not limited to, mobile gaming devices 100A, cellular telephones 100A, game consoles 100B, personal data assistants 100A, etc.

Network 10 comprises a radio access network (RAN) 20, a core network (CN) 30, and an IP Multimedia Subsystem (IMS) 40. RAN 20 supports radio communications with mobile devices 100A over an air interface. A mobile device 100A is a networked communication device as that term is used herein. Network 10 typically includes more than one RAN 20, though only one is shown in FIG. 1 for simplicity.

The CN 30 provides a connection to the Internet 12 or other packet data network (PDN) for packet switched services such as web browsing and email, and may provide a connection to the Public Switched Telephone Network (PSTN) and/or the Integrated Digital Services Network (ISDN) 16 for circuit-switched services such as voice and fax services. CN 30 may, for example, comprise a General Packet Radio Services (GPRS) network, cdma2000 network, or UMTS network. The CN 30 includes an access gateway 32 for interconnecting with IMS 40. Access gateway 32 may comprise a GPRS Gateway Serving Node (GGSN) for GPRS networks or a Packet Data Serving Node (PDSN) for cdma2000 networks.

IMS 40 provides access independent, IP-based multi-media services to mobile devices 100A and supports a variety of IP services including voice over IP (VoIP), video and audio streaming, email, web browsing, videoconferencing, instant messaging, online gaming, and other services. IMS 40 was developed to provide a common, standardized architecture and standardized interfaces for providing IP services in a mobile networking environment. The IMS 40 is not dependent on the access technology and will interoperate with virtually any packet-switched network, including UMTS, cdma2000, GPRS and EDGE networks.

IMS 40 uses open interfaces and an access independent session control protocol (SCP), such as the Session Initiation Protocol (SIP), to support multi-media applications. Session description protocol (SDP) is used for media negotiation. SDP is described in IETF RFCs 2327 and 3264. SIP is a session control protocol for establishing, modifying, and terminating communication sessions between one or more participants. These sessions may include, for example, Internet multimedia conferences, Internet telephony calls, Internet gaming, and multimedia distributions. SIP is described in the IETF document RFC 3261. While a preferred embodiment of the invention as described herein uses the SIP, those skilled in the art will appreciate that the present invention may use other SCPs as well. For example, another well-known protocol comparable to the SIP is H. 323.

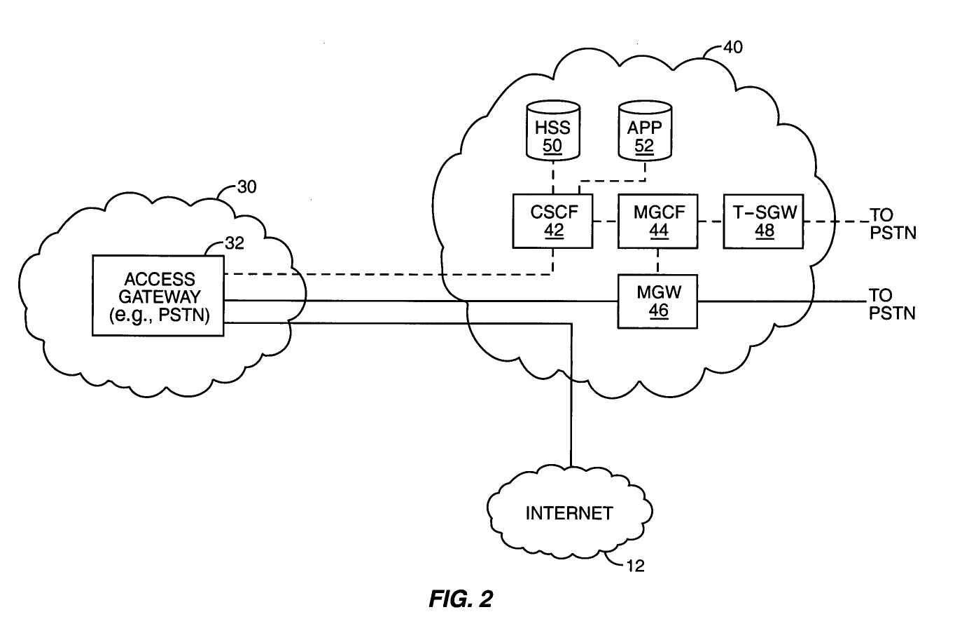

FIG. 2 illustrates the basic elements of the IMS 40 and its relationship to the CN 30. The IMS 40 includes one or more Call State Control Functions (CSCFs) 42, a Media Gateway Control Function (MGCF) 44, a Media Gateway (MGW) 46, a Transport Signaling Gateway (T-SGW) 48, and a Home Subscriber Server (HSS) 50, which are interconnected by an IP network. The IMS 40 may further include an application server 52 providing multimedia services to mobile devices 100A. The CSCFs 42 function as SIP servers to process session control signaling used to establish, modify, and terminate a communication session. Functions performed by the CSCFs 42 include call control, address translation, authentication, capability negotiation, and subscriber profile management. The HSS 50 interfaces with the CSCFs 42 to provide information about the subscriber's current location and subscription information. The application server 52 provides multimedia services or other IP services to mobile devices 100A. The MGCF 44, MGW 46 and T-SGW 48 support inter-working with external networks, such as the Internet 12, PSTN, or ISDN. The MGCF 44 controls one or more MGWs 46 that manage the connections between the external network and the IMS 40. The MGCF 44 configures the MGW 46 and converts SIP messages into a different format, such as ISDN User Part (ISUP) messages. The MGCF 44 forwards the converted messages to the T-SGW 48, which interfaces the IMS 40 to external signaling network, such as the SS7 network. The T-SGW 48 includes a protocol converter to convert IP messages to SS7 and vice versa. IMS 40 may include additional elements, which are not shown in FIG. 2 and are not important to understand the present invention.

Mobile devices 100A may include a media client that provides SIP and/or IMS capabilities. Alternatively, network 10 may include a media client that may be accessed remotely by mobile devices 100A to provide the mobile device 100A with SIP and/or IMS capabilities. Additional details about a network-centric media client that provides mobile devices with SIP and/or IMS capabilities is presented in U.S. patent application Ser. No. 11/114,427 filed 26 Apr. 2005, which is incorporated herein by reference.

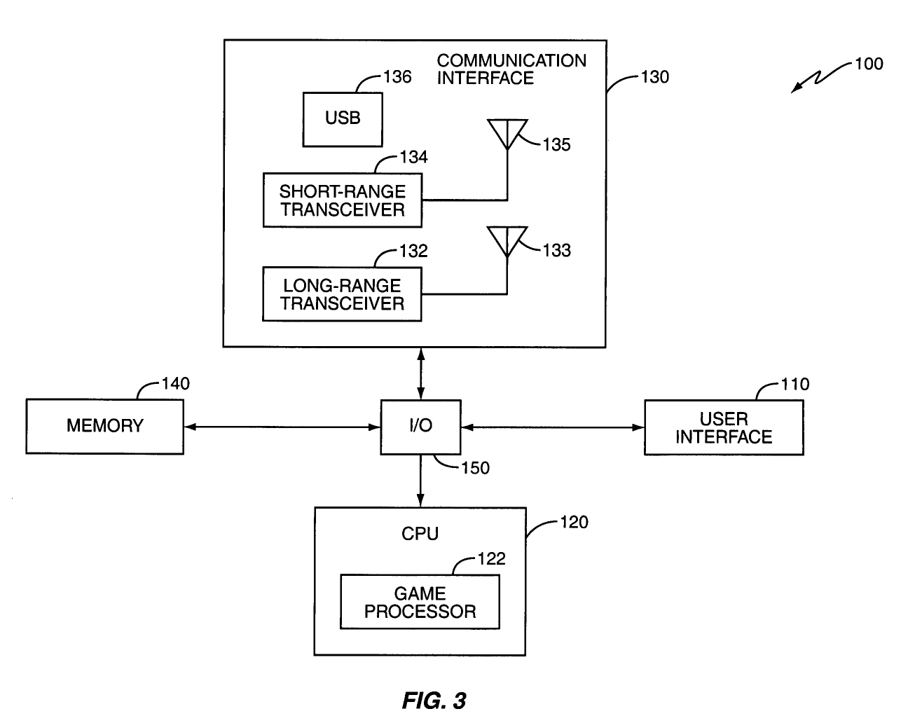

An exemplary gaming device 100, such as a mobile device 100A or a game console 100B, includes a user interface 110, a central processing unit (CPU) 120, a communication interface 130, a memory circuit 140, and an input/output (I/O) circuit 150, as shown in FIG. 3. User interface 110 may comprise a display, microphone, speaker, control buttons, and/or joystick controls. Using these tools, user interface 110 communicates with CPU 120 via I/O 150 to enable a user to interface with and control the gaming device 100. CPU 120 responds to user commands and program code stored in memory 140 to control the device 100, as is well understood in the art. In addition, CPU 120 includes a game processor 122 that executes program code stored in memory 140 for a user-selected game from a current game state based on information provided by the user via the user interface 110, as discussed below.

Communication interface 130 operates as an interface between the gaming device 100 and the network 10. To that end, communication interface 130 includes a short-range transceiver 134 and at least one cable port, such as a USB port 136. Short-range transceiver 134 operates as a short-range wireless interface, such as an infrared interface or the interface defined by the Bluetooth® standard, to exchange information with other gaming devices 100 via antenna 135. In addition, short-range transceiver 134 interfaces the game console 100B with one or more game controllers 112, as is well understood in the art.

USB port 136 operates as a fixed interface between the gaming device 100 and external devices, such as game controllers, other gaming devices 100 in network 10, etc. While FIG. 3 illustrates that communication interface 130 includes only one USB port 136, those skilled in the art will appreciate that communication interface 130 may include multiple USB ports 136, and may further include other types of fixed communication ports not shown, i.e., serial and/or parallel that exchange information over a cable connection.

When part of a mobile device 100A, communication interface 130 may also include a long-range transceiver 132 and antenna 133 for establishing a wireless IP session using IMS 40 and/or for interfacing with remote devices 100 in network 10 via RAN 20. For multi-player game applications, long-range transceiver 132 exchanges game state information and control signals over a wireless network 10 with an application server 52 to participate in multi-player games played on other remote gaming devices 100, as described below.

Generally, online multi-player gaming requires a designated server in network 10, i.e., game application server 52, that interfaces with one or more clients, i.e., game consoles 100B, where the game server 52 and the game consoles 100B execute the same program code. As shown in FIG. 1, the game server 52 may be a separate server in the network 10. However, those skilled in the art will appreciate that one of the game consoles 100B may operate as the server, while the remaining game console(s) 100B operate as clients.

Generally, implementing multi-player games involves a game set-up phase and a game play phase for each game console 100B involved in the game. During game set-up, game server 52 provides each game console 100B entering the game with an initial game state, which includes information relevant to each game console's player. For example, in a multi-player shooter, the initial game state may include a player's initial location, number and type of weapons, ammunition count, visible enemies and/or teammates, etc. During game play, the game server 52 periodically updates the current game state in each game console 100B by sending a new game state to each game console 10B. In addition, one or more game consoles 100B may establish a separate communication session (audio and/or video) that enables the players to communicate, i.e., taunt, coordinate, etc., while playing the game. These communication sessions are established according to known communication protocols, and therefore, are not discussed further herein.

During the game-play phase, one or more players may experience interruptions that prevent them from continuing the game from the game console 100B. To provide additional game playing flexibility, the present invention enables a player to switch from a game console 100B to a mobile device 100A, and to resume play on the mobile device 100A without losing his or her position in the game.

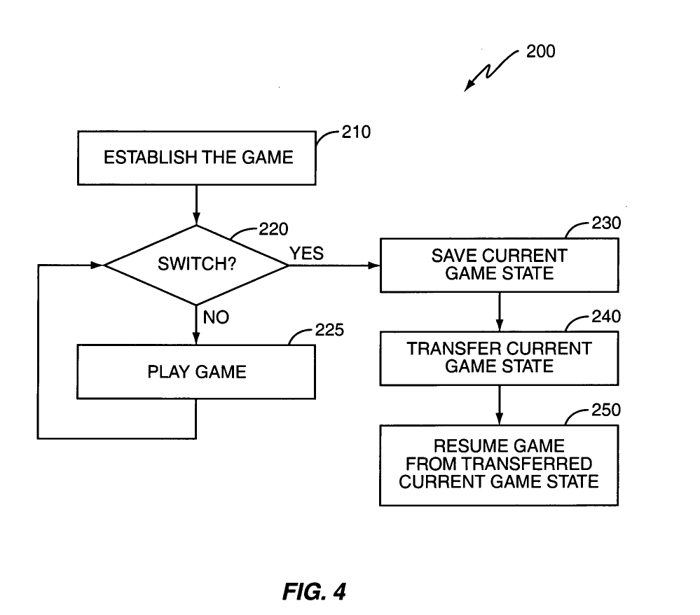

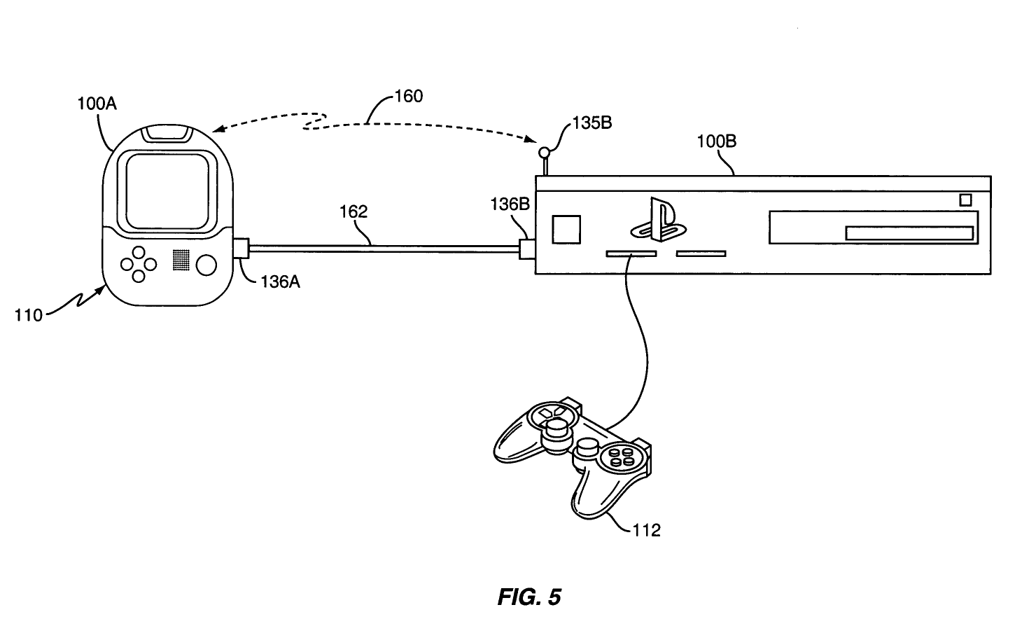

FIG. 4 illustrates one exemplary method 200 of the present invention. According to the exemplary method 200, each participating game console 100B establishes the game online (block 210) by establishing a game session according to known means. When a player is ready to switch from the game console 100B to a mobile device 100A, the game console 100B stores a current game state in memory 140 (block 230), and transfers the current game state to the mobile device 100A (block 240). As shown in FIG. 5, game console 100B may transfer the game state to mobile device 100A over a short-range wireless interface 160. Alternatively, game console 100B may transfer the game state to mobile device 100A over a cable interface using a cable 162, such as a USB cable. In any event, after receiving the game state, mobile device 100A establishes a connection with network 10 via RAN 20, as discussed above, to establish a game session. Subsequently, mobile device 100A resumes the game online from the received current game state (block 250) by executing program code stored in memory 140. Upon resuming the game, mobile device 100A may synchronize the received current game state with the latest game state in game server 52 to account for any changes that occurred in the game state due to other player's actions, i.e., changes to the number of visible enemies, location of enemies, etc.

Like the game console 100B, mobile device 100A may also establish a voice communication session separate from the game session to allow players to communicate while playing the game. To that end, long-range transceiver 132 in mobile device 100A interfaces with RAN 20 to establish the voice session according to known wireless protocols.

If the memory 140 in mobile device 100A does not already include the program code for the desired game, game console 100B may also transfer the program code or some subset of the program code appropriate for the particular mobile device 100A. In this scenario, mobile device 100A executes the received program code to resume the game online from the received current game state.

The above describes the present invention in terms of a multi-player game. However, the present invention may also be applied to single-player games, including multi-player games where there is only one player. According to this embodiment, a player engaged in a single-player game on a game console 100B may store a current game state on the game console 100B. After transferring the current game state, and optionally, the program code for the game to a mobile device 100A, the player may resume play from the current game state on the mobile device 100A. As a result, the player can continue the game instead of resigning.

While the present invention has been described in terms of a multi-player game played with game consoles 100B over an online network, the present invention also applies to other networks, such as wireless LANs, Bluetooth, etc. For example, two brothers playing a multi-player game in their living room may transfer the current game state to two separate mobile devices 100A and resume the game from the current game state using their mobile devices 100A to enable them to continue the game in the car.

Further, the above describes the present invention in terms of the game console 100B transferring the game state to the mobile device 100A. However, the present invention is not so limited. A player may also switch game play from the mobile device 100A to the game console 100B. According to this embodiment, the mobile device 100A stores the current game state, and transfers the current game state to the game console 100B over the short-range wireless interface or the cable interface. The game console then resumes the game online using the received current game state.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

We claim:

1. A method of playing an electronic game online, the method comprising:
establishing the game using a game console;
saving a current game state;
transferring the saved game state from the game console to a mobile device; and
resuming the game online from the saved game state using the mobile device.

2. The method of claim 1 wherein transferring the saved game state comprises transferring the saved game state over a short-range wireless interface.

3. The method of claim 1 further comprising transferring program code for the electronic game from the game console to the mobile device, wherein resuming the game comprises resuming the game online from the saved game state using the program code.

4. The method of claim 1 wherein the mobile device comprises at least one of a mobile gaming device and a cellular telephone.

5. The method of claim 1 further comprising:
saving a second game state on the mobile device;
transferring the second saved game state from the mobile device to the game console; and
resuming the game online from the second saved game state using the game console.

6. The method of claim 1 wherein establishing and resuming the electronic game comprises establishing and resuming a multi-player electronic game.

7. The method of claim 1 further comprising establishing at least one of a concurrent audio session and a video session between the mobile device and a remote device to enable players to communicate while playing the game.

8. A method of playing an electronic game online using a mobile device, the method comprising:
receiving a saved game state from a game console; and
resuming the electronic game online from the saved game state.

9. The method of claim 8 wherein receiving the saved game state comprises receiving the saved game state from the game console over a short-range wireless interface.

10. The method of claim 8 further comprising receiving program code for the game program from the game console for execution in said mobile device.

11. The method of claim 8 wherein the mobile device comprises at least one of a mobile gaming device and a cellular telephone.

12. The method of claim 8 further comprising:
saving a second game state on the mobile device;
transferring the second game state from the mobile device to the game console; and
resuming the game online from the second game state using the game console.

13. The method of claim 8 further comprising establishing at least one of a concurrent audio session and a video session between the mobile device and a remote device to enable players to communicate while playing the game.

14. A game console comprising:
a processor configured to establish an electronic game and further configured to save the game state; and
a communication circuit configured to transfer the saved game state from the game console to an external mobile device.

15. The game console of claim 14 wherein the communication circuit includes a USB interface for transferring the saved game state to the external mobile device via a USB cable.

16. The game console of claim 14 wherein the communication circuit includes a short-range wireless transceiver for transferring the saved game state to the external mobile device over a short-range wireless network.

17. The game console of claim 14 wherein the communication circuit is further configured to receive a second saved game state from the mobile device, and wherein the processor is further configured to resume the game online from the second saved game state.

18. The game console of claim 14 wherein the processor is configured to establish a multi-player electronic game over an online network.

19. A mobile device comprising:
a communication circuit configured to receive a saved game state from a game console;
a game processor configured to resume an electronic game from the saved game state over a wireless network.

20. The mobile device of claim 19 wherein the mobile device comprises at least one of a mobile gaming device and a cellular telephone.

21. The mobile device of claim 19 wherein the game processor is further configured to save a second game state, and wherein the communication circuit is further configured to transfer the second saved game state to the game console.

22. The mobile device of claim 19 wherein the communication circuit is further configured to receive program code for the game from the game console, and wherein the game processor is further configured to resume the game using the received program code.

23. The mobile device of claim 19 wherein the communication circuit includes a USB interface for receiving the saved game state from the game console via a USB cable.

24. The mobile device of claim 19 wherein the communication circuit includes a short-range wireless transceiver for receiving the saved game state from the game console via a short-range wireless network.

25. The mobile device of claim 19 further comprising a long-range wireless transceiver configured to exchange game commands with at least one of a remote game console and a remote mobile device over the wireless network.

26. The mobile device of claim 25 wherein the long-range wireless transceiver is further configured to establish at least one of a concurrent audio session and a video session between the mobile device and a remote device to enable players to communicate while playing the game.

27. The mobile device of claim 19 wherein the electronic game comprises a multi-player electronic game.

28. A gaming system comprising:
a game console comprising:
a console processor configured to establish an electronic game, and
further configured to save a current game state of the game; and
a mobile device comprising:
a mobile communication circuit for receiving the saved game state from the game console over an established interface;
a mobile game processor configured to resume the electronic game online from the saved game state over a wireless network.

29. The gaming system of claim 28 wherein the mobile device comprises at least one of a mobile gaming device and a cellular telephone.

30. The gaming system of claim 28 wherein the mobile communication circuit is further configured to receive program code for the game from the game console, and wherein the game processor is further configured to resume the game from the saved game state according to the received program code.

31. The gaming system of claim 28 wherein the mobile device further comprises a long-range wireless transceiver configured to exchange game commands with at least one of a different game console and a different mobile device over the wireless network.

32. The gaming system of claim 28 wherein the long-range wireless transceiver is further configured to establish at least one of a audio session and a video session between the mobile device and a remote device to enable players to communicate while playing the game.

33. The gaming system of claim 28 wherein the game console further comprises a console communication circuit configured to transfer the saved game state to the mobile communication circuit.

34. The gaming system of claim 33 wherein the console communication circuit and the mobile communication circuit each include a USB interface for transferring the saved game state via a USB cable.

35. The gaming system of claim 33 wherein the console communication circuit and the mobile communication circuit each includes a short-range wireless transceiver for transferring the saved game state over a short-range wireless network.

36. The gaming system of claim 33 wherein the mobile game processor is further configured to save a second game state, and wherein the mobile communication circuit is further configured to transfer the second saved game state from the mobile device to the console communication circuit

37. The gaming system of claim 36 wherein the console processor is further configured to resume the game online from the second saved game state.

38. The gaming system of claim 28 wherein the console processor establishes a multi-player game over an online network, and wherein the mobile game processor resumes the multi-player game online from the saved game state.
